(19) United States
(12) Patent Application Publication
(10) Pub. No.: US 2016/0305591 A1
(43) Pub. Date: Oct. 20, 2016

(54) GRIPPER TYPE DUAL STOP-REVERSAL QUICK-RELEASE CONNECTOR STRUCTURE, AND WATER SUPPLY DEVICE AND WATER-COOLING SYSTEM THEREOF

(71) Applicant: COOLER MASTER CO., LTD., NEW TAIPEI CITY (TW)

(72) Inventors: HSIN-HUNG CHEN, NEW TAIPEI CITY (TW); SHUI-FA TSAI, NEW TAIPEI CITY (TW)

(21) Appl. No.: 14/688,535

(22) Filed: Apr. 16, 2015

(51) Int. Cl. F16L 37/22; F01N 3/04; E03B 7/09; F16L 25/00; E03B 7/07

(52) U.S. Cl. CPC F16L 37/22; F16L 25/0018; F16L 25/009; E03B 7/07; E03B 7/09; F01N 3/046

(57) ABSTRACT

In a gripper type dual stop-reversal quick-release connector structure, and its water supply device and water-cooling system, the connector structure includes a first joint having a first containing chamber, a first stop-reversal member installed in the first containing chamber and a second joint having a second containing chamber and a second stop-reversal member installed in the second containing chamber, and the first and second joints are engaged to abut first and second stop-reversal members with each other. The external periphery of the front end of the first joint has plural grippers and the front end of the second joint has a pipe connecting portion, and each gripper is sheathed on the pipe connecting portion, and the external periphery of the pipe connecting portion has a radial flange corresponsive to each gripper, so that each gripper may be latched onto the radial flange for fixation.

### FIELD OF THE INVENTION

The present invention relates to a pipe connector, and more particularly to a gripper type dual stop-reversal quick-release connector and its water supply device and water-cooling system.

### BACKGROUND OF THE INVENTION

In a conventional water-cooling system or water supply device, a circulation pipeline is generally formed by serially connecting components such as a pump, a water tank, a water block and a water-cooled exhaust. After a long time of use, water may leak from the pipeline, so that it is necessary to prevent leakage by a check valve, regardless of the operations such as changing components or refilling water. Therefore, a quick-release connector is introduced and provided for fluid pipelines.

However, a conventional connector cannot be fixed or positioned directly after the connector is plugged or connected, and the connector achieves its fixing effect by the connection between a pump and a water tank. For example, a latch is designed for combining a pump and a water tank, and the two connectors are disposed between the pump and the water tank. After the pump and the water tank are combined, the two connectors are connected to achieve the fixing effect. Obviously, conventional connectors do not come with a good positioning effect after they are connected, and they rely on other components for the fixation. If no other direct joint exists between the two connectors, then the connectors may not be positioned securely after they are plugged or connected, so that the conventional connectors require improvements and solutions.

In view of the aforementioned drawbacks of the prior art, the inventor of the present invention invented the present invention to overcome the drawbacks of the prior art.

### SUMMARY OF THE INVENTION

Therefore, it is a primary objective of the present invention to provide a gripper type dual stop-reversal quick-release connector, and its water supply device and water-cooling system. With the design of grippers, the connectors can be interconnected while achieving the positioning effect.

To achieve the aforementioned and other objectives, the present invention provides a gripper type dual stop-reversal quick-release connector comprising a first joint and a second joint, wherein the first joint has a first containing chamber interconnected to the front and rear ends of the first joint, and a first stop-reversal member installed in the first containing chamber, and the second joint has a second containing chamber interconnected to the front and rear ends of the second joint and a second stop-reversal member installed in the second containing chamber, and the second joint is engaged with the first joint, such that the first and second stop-reversal members abut against each other, and the first and second containing chambers are interconnected to each other, wherein, the first joint has a plurality of grippers disposed around the external periphery of the front end of the first joint, and the second joint has a pipe connecting portion disposed at the front end of the second joint, and the grippers are sheathed on the pipe connecting portion, and the external periphery of the pipe connecting portion has a radial flange corresponsive to the grippers, and each gripper is latched to the radial flange for fixation.

To achieve the aforementioned objective, the present invention further provides a water supply device of a gripper type dual stop-reversal quick-release connector, comprising a pump, a water tank, and at least one first joint and at least one second joint connected between the pump and the water tank, wherein the first joint has a first containing chamber interconnected to the front and rear ends of the first joint, and the first containing chamber includes a first stop-reversal member installed therein; the second joint has a second containing chamber interconnected to the front and rear ends of the second joint, and the second containing chamber includes a second stop-reversal member installed therein, and the second joint is engaged with the first joint, such that the first and second stop-reversal members abut each other, and the first and second containing chambers are interconnected to each other; and the first joint has a plurality of grippers disposed around the external periphery of the front end of the first joint, and the second joint has a pipe connecting portion disposed at the front end of the second joint, and the grippers are sheathed on the pipe connecting portion, and the pipe connecting portion has a radial flange disposed at the external periphery of the pipe connecting portion and corresponsive to the grippers, and each gripper is latched to the radial flange for fixation.

To achieve the aforementioned objective, the present invention further provides a water-cooling system of a gripper type dual stop-reversal quick-release connector comprising a pump, a water tank, a water block, a water-cooled exhaust, and a circulation pipeline serially connected to the pump, the water tank, the water block and the water-cooled exhaust, and the circulation pipeline has at least one first joint and at least one second joint, wherein the first joint has a first containing chamber interconnected to the front and rear ends of the first joint, and the first containing chamber includes a first stop-reversal member installed therein; the second joint has a second containing chamber interconnected to the front and rear ends of the second joint, and the second containing chamber includes a second stop-reversal member installed therein, and the second joint is engaged with the first joint, such that the first and second stop-reversal members abut each other, and the first and second containing chambers are interconnected to each other; and the first joint has a plurality of grippers disposed around the external periphery of the front end of the first joint, and the second joint has a pipe connecting portion disposed at the front end of the second joint, and the grippers are sheathed on the pipe connecting portion, and the pipe connecting portion has a radial flange disposed at the external periphery of the pipe connecting portion and corresponsive to the grippers, and each gripper is latched to the radial flange for fixation.

### BRIEF DESCRIPTION OF THE DRAWINGS

FIG. 1 is an exploded view of the present invention;

FIG. 2 is an exploded view of a first joint of the present invention;

FIG. 3 is an exploded view of a second joint of the present invention;

FIG. 4 is a cross-sectional view of first and second joints of the present invention being separated from each other;

FIG. 5 is a cross-sectional view of first and second joints of the present invention being connected to each other;

FIG. 6 is a schematic view of the present invention being applied to a water supply device;

FIG. 7 is a schematic view of the present invention being applied to a water-cooling system.

### DESCRIPTION OF THE PREFERRED EMBODIMENTS

The technical contents of the present invention will become apparent with the detailed description of preferred embodiments accompanied with the illustration of related drawings as follows.

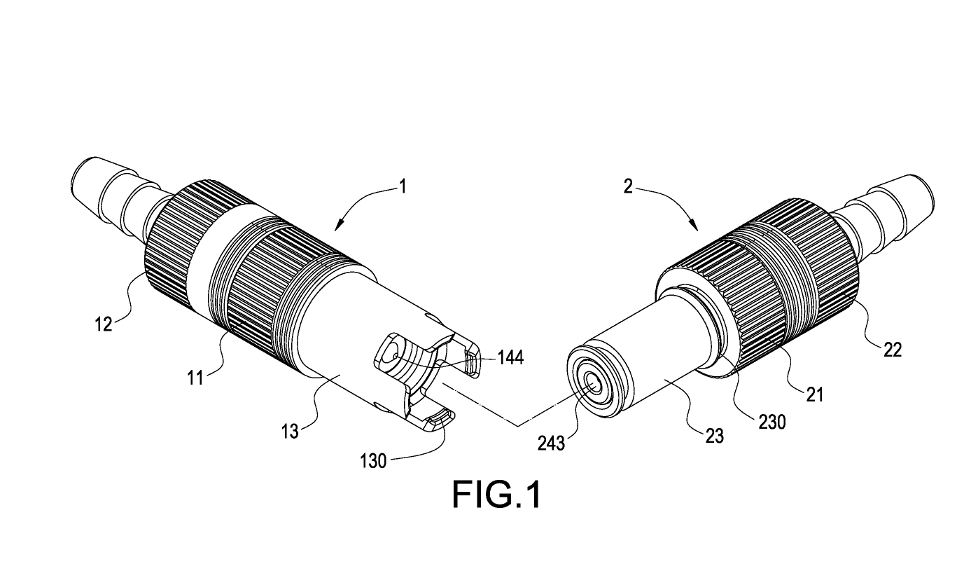

With reference to FIGS. 1 to 3 for the exploded views of a gripper type dual stop-reversal quick-release connector, a first joint, and a second joint in accordance with the present invention respectively, the gripper type dual stop-reversal quick-release connector, and its water supply device and water-cooling system are primarily applied to pipelines such as those for transmitting fluids. During the process of transmitting the fluids through the pipeline, the connector structure may separate the pipeline to interrupt the transmission without causing leakage of the fluid from the pipeline. The connector structure comprises a first joint 1, and a second joint 2 connected to the first joint 1.

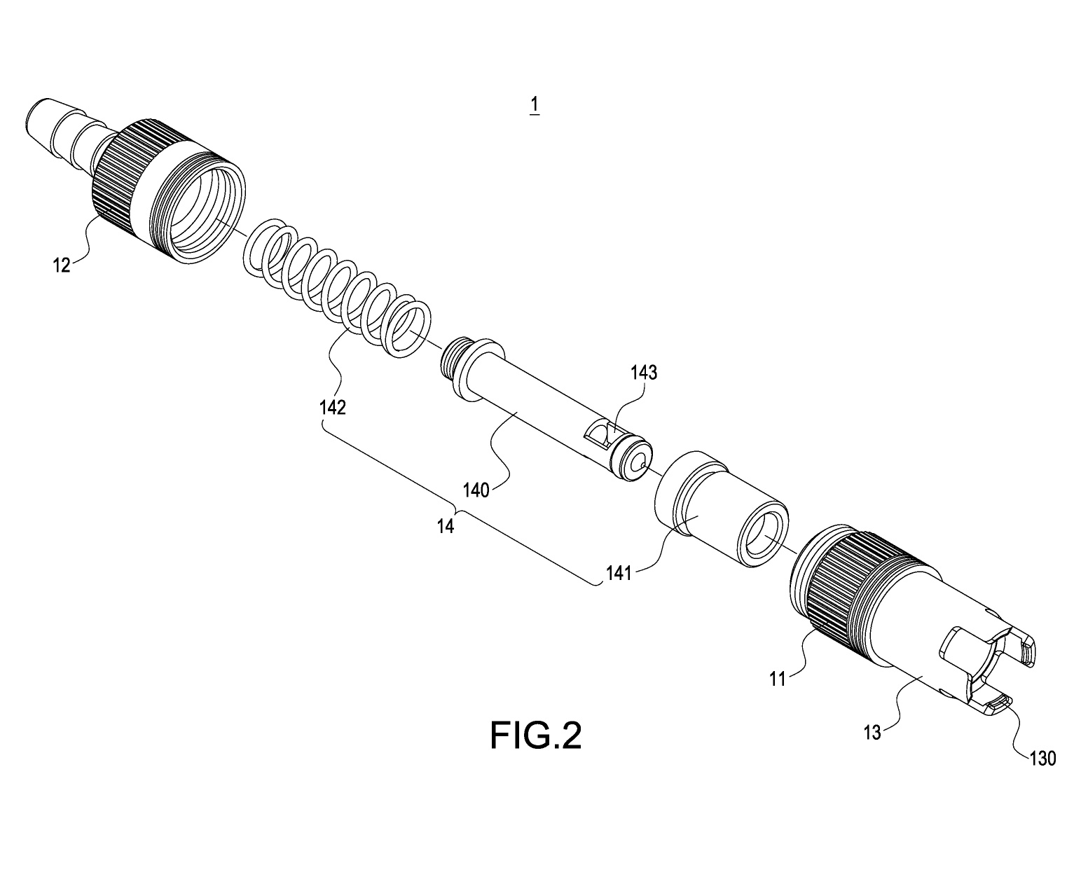

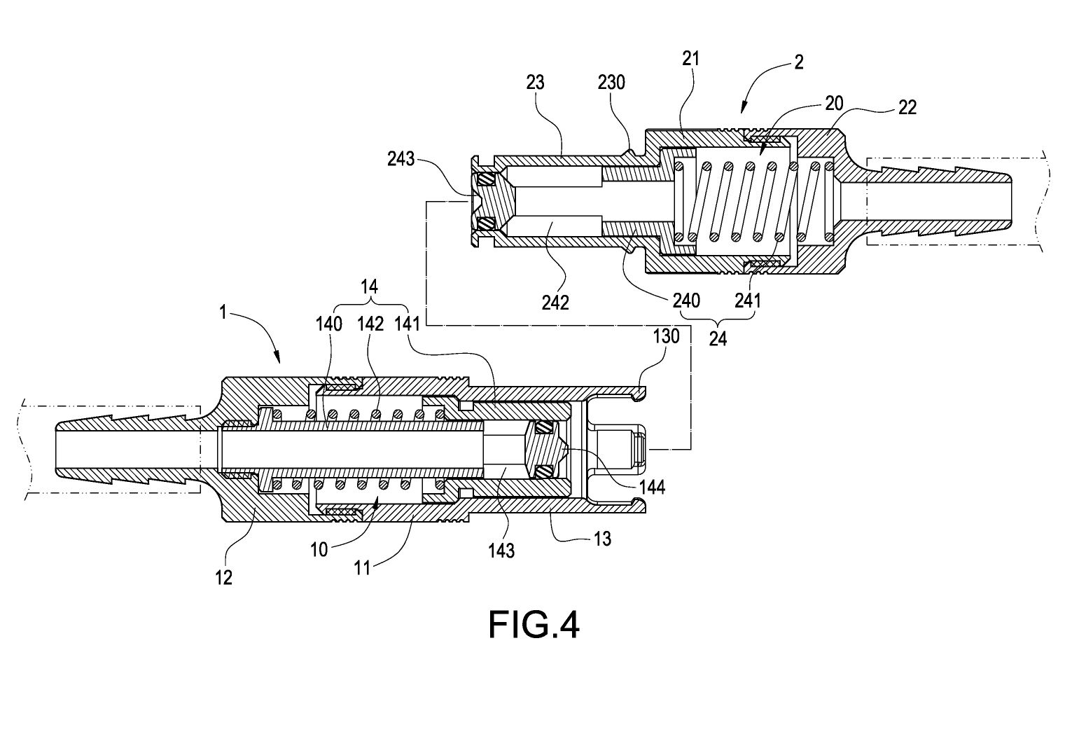

With reference to FIGS. 2 and 4, the interior of the first joint 1 is hollow and the first joint 1 has a first containing chamber 10 interconnected to the front and rear ends of the first joint 1 for passing a fluid. In a preferred embodiment of the present invention, the first joint 1 includes a first body 11, a first pipe member 12 installed at the rear end of the first body 11, and a bushing portion 13 extended from the front end of the first body 11, and the first containing chamber 10 is an internal space formed after the aforementioned components are assembled. In addition, the first joint 1 in the first containing chamber 10 includes a first stop-reversal member 14 used for separating the first containing chamber 10 from the outside and normally shutting the first containing chamber 10. In a preferred embodiment of the present invention, the first stop-reversal member 14 includes a hollow first pipe 140, a pushing member 141 sheathed on the front end of the first pipe 140, and a first elastic member 142 for pushing the pushing member 141 towards the bushing portion 13, and the first elastic member 142 may be installed between the first pipe 140 and the pushing member 141, and the rear end of the first pipe 140 is interconnected to the rear end of the first pipe member 12, and a first broken hole 143 is formed at a position proximate to the front end of the first pipe 140 and interconnected to the interior of the first pipe 140, and the front end of the first pipe 140 has a first pushing portion 144, and the first pushing portion 144 is in a convex conical shape, and the pushing member 141 is installed between the first broken hole 143 and the periphery of the first pushing portion 144 for blocking the front end of the first pipe 140, so as to prevent the fluid contained in the first containing chamber 10 from leaking from the front end of the first pipe 140.

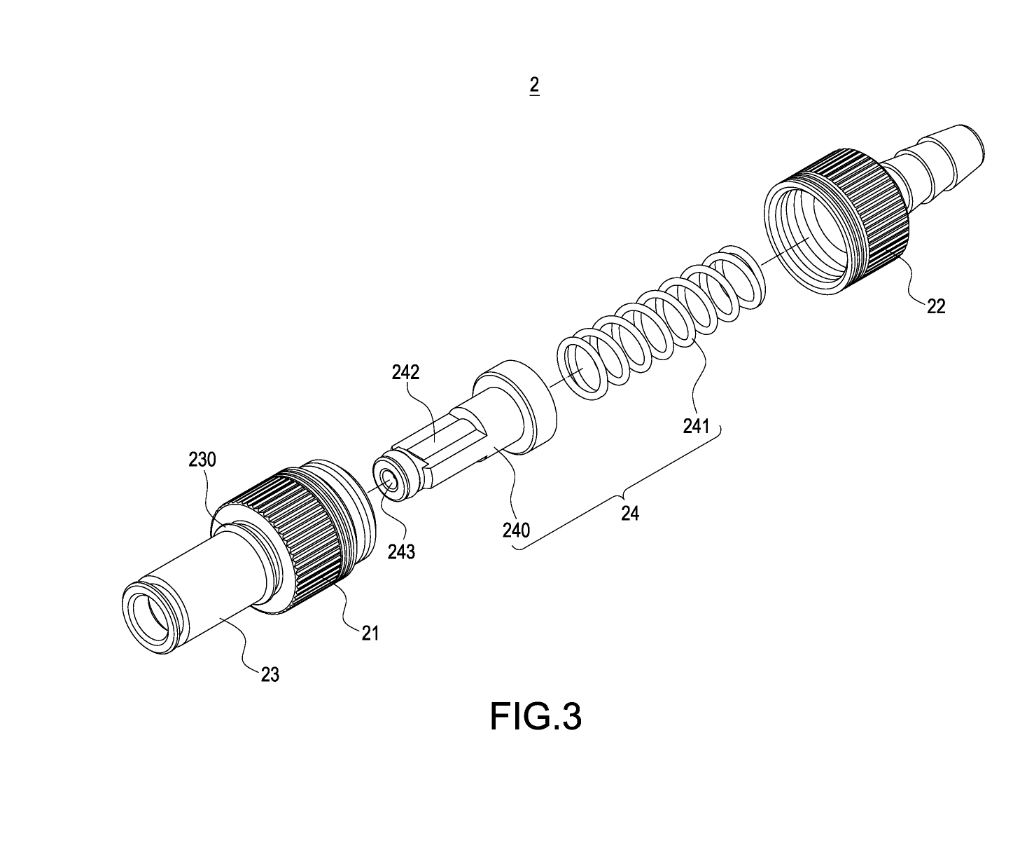

In FIGS. 3 and 4, the second joint 2 is hollow and has a second containing chamber 20 interconnected to the front and rear ends of the second joint 2 for passing a fluid. In a preferred embodiment of the present invention, the second joint 2 includes a second body 21, a second pipe member 22 installed at the rear end of the second body 21, and a pipe connecting portion 23 extended from the front end of the second body 21, and the second containing chamber 20 is an internal space formed after the aforementioned components are assembled. In addition, the second joint 2 in the second containing chamber 20 has a second stop-reversal member 24 for blocking the second containing chamber 20 from the outside and normally shutting the second containing chamber 20. In a preferred embodiment of the present invention, the second stop-reversal member 24 includes a hollow second pipe 240, and a second elastic member 241 for pushing the second pipe 240 towards the pipe connecting portion 23, and the second elastic member 241 may be installed between the second pipe 240 and the second pipe member 22, and the rear end of the second pipe 240 is passed through the second containing chamber 20 and interconnected to the rear end of the second pipe member 22, and a second broken hole 242 is formed at a position proximate to the front end of the second pipe 240 and interconnected to the second pipe 220, and a second pushing portion 243 is disposed at the front end of the second pipe 240, and the second pushing portion 243 is in a concave conical shape and corresponsive to the first pushing portion 144. The pipe connecting portion 23 is sheathed on the second broken hole 242 and the periphery of the second pushing portion 243 for blocking the front end of the pipe connecting portion 23, so as to prevent the fluid contained in the second containing chamber 20 from leaking from the front end of the pipe connecting portion 23.

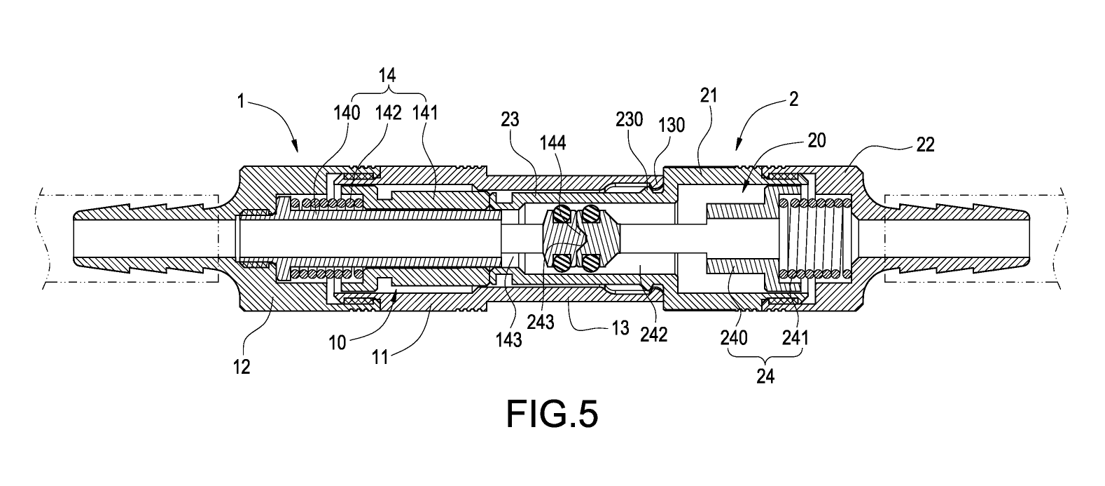

In FIG. 5, if the first joint 1 and the second joint 2 are engaged with each other, the bushing portion 13 of the first joint 1 will be sheathed on and passed out from the pipe connecting portion 23 of the second joint 2, and thus the first pushing portion 144 of the first stop-reversal member 14 will be contacted with the second pushing portion 243 of the second stop-reversal member 24. If the bushing portion 13 is being sheathed continuously on the pipe connecting portion 23 to shorten the distance between the first and second joints 1, 2, the first and second stop-reversal members 14, 24 will be abutted with each other, so that each elastic member (such as the first elastic member 142 and the second elastic member 241) is compressed, and one elastic member pushes the pipe connecting portion 23 to abut the pushing member 141 of the first stop-reversal member 14 against the first pipe 140 to move towards the rear end of the first joint 1, and the other elastic member pushes the first pushing portion 144 to abut the second pushing portion 243 of the second stop-reversal member 24 to move towards the second joint 2, so that the first broken hole 143 of the first pipe 140 will be interconnected to the pipe connecting portion 23, and the second broken hole 242 of the second pipe 240 is interconnected to the second pipe 240, so as to pass through the second containing chamber 20 to the rear end of the second pipe member 22 and achieve the effect of interconnecting the first and second joints 1, 2.

In FIGS. 1 and 5, the present invention comprises a plurality of grippers 130 disposed around the external periphery of the front end of the first joint 1, and the grippers 130 may be extended from the bushing portion 13 of the first joint 1, and the grippers 130 are sheathed on the pipe connecting portion 23 of the second joint 2, and the external periphery of the pipe connecting portion 23 has a radial flange 230 corresponsive to each gripper 130 for latching each gripper 130 onto the radial flange 230, so that when the bushing portion 13 of the first joint 1 is sheathed onto the pipe connecting portion 23 of the second joint 2, the two are latched for fixation.

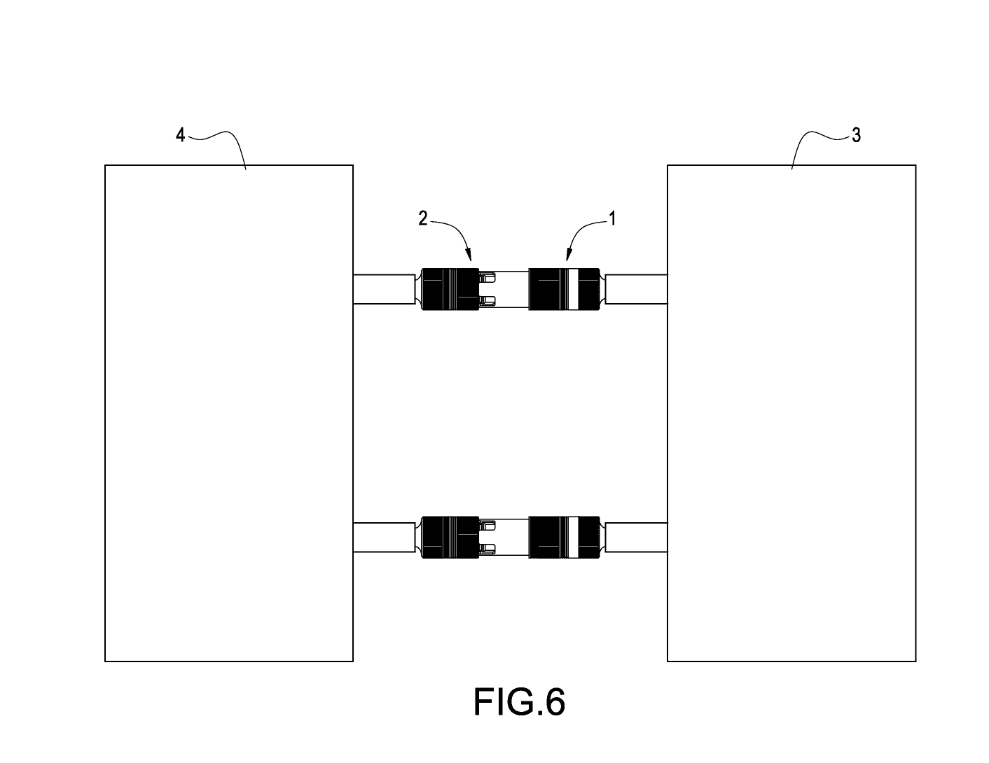

In FIG. 6, the present invention further provides a water supply device with a gripper type dual stop-reversal quick-release connector, comprising: a pump 3, a water tank 4, and at least one first joint 1 and at least one second joint 2 connected between the pump 3 and the water tank 4. Therefore, the water supply device may be removed or replaced with respect to the pump 3 or the water tank 4 easily.

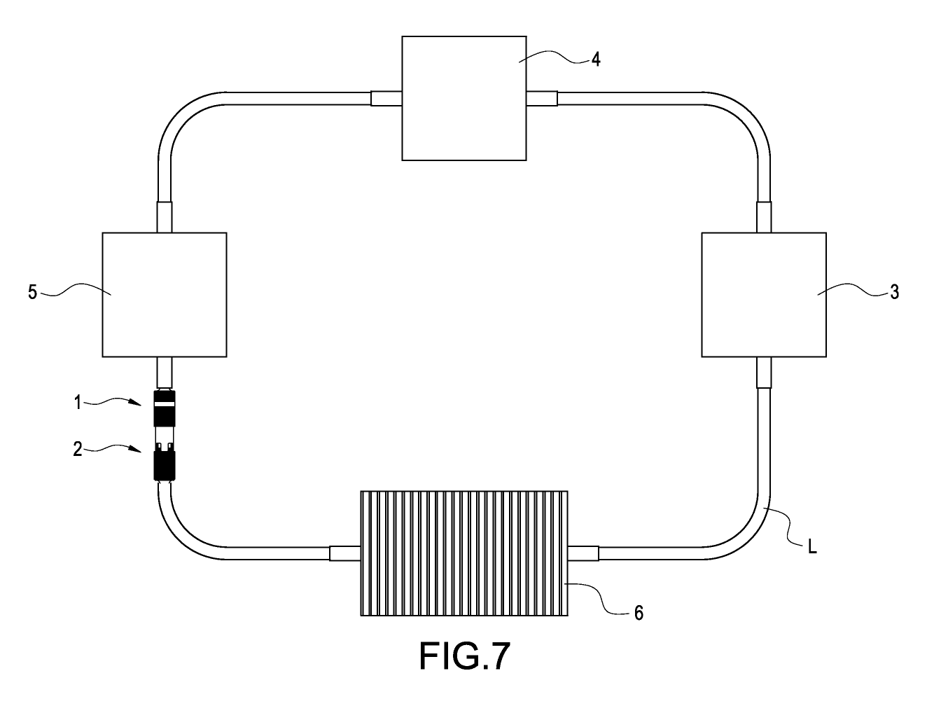

In FIG. 7, the present invention further provides a water-cooling system with a gripper type dual stop-reversal quick-release connector, comprising: a pump 3, a water tank 4, a water block 5, a water-cooled exhaust 6, and a circulation pipeline L serially connected to the aforementioned components. Wherein, the circulation pipeline L includes at least one first joint 1 and at least one second joint 2 for connection. Therefore, the circulation pipeline L or the serially connected components of the circulation pipeline L of the water-cooling system may be removed or replaced easily.

While the invention has been described by means of specific embodiments, numerous modifications and variations could be made thereto by those skilled in the art without departing from the scope and spirit of the invention set forth in the claims.

What is claimed is:

1. A gripper type dual stop-reversal quick-release connector, comprising:
a first joint, having a first containing chamber interconnected to the front and rear ends of the first joint, and a first stop-reversal member installed in the first containing chamber; and
a second joint, having a second containing chamber interconnected to the front and rear ends of the second joint and a second stop-reversal member installed in the second containing chamber, and the second joint being engaged with the first joint, such that the first and second stop-reversal members abut against each other, and the first and second containing chambers are interconnected to each other;
wherein, the first joint has a plurality of grippers disposed around the external periphery of the front end of the first joint, and the second joint has a pipe connecting portion disposed at the front end of the second joint, and the grippers are sheathed on the pipe connecting portion, and the external periphery of the pipe connecting portion has a radial flange corresponsive to the grippers, and each gripper is latched to the radial flange for fixation.

2. The gripper type dual stop-reversal quick-release connector according to claim 1, wherein the first joint includes a first body, a first pipe member installed at the rear end of the first body, and a bushing portion extended from the front end of the first body.

3. The gripper type dual stop-reversal quick-release connector according to claim 2, wherein the grippers are extended from the bushing portion.

4. The gripper type dual stop-reversal quick-release connector according to claim 2, wherein the first stop-reversal member includes a hollow first pipe, a pushing member sheathed on the front end of the first pipe, and a first elastic member provided for pushing the pushing member towards the bushing portion, and the rear end of the first pipe is interconnected to the rear end of the first pipe member, and a first broken hole is formed at a position proximate to the front end of the first pipe and interconnected to the interior of the first pipe, and a first pushing portion is disposed at the front end of the first pipe.

5. The gripper type dual stop-reversal quick-release connector according to claim 4, wherein the first elastic member is installed between the first pipe and the pushing member.

6. The gripper type dual stop-reversal quick-release connector according to claim 4, wherein the first pushing portion is in a convex conical shape.

7. The gripper type dual stop-reversal quick-release connector according to claim 4, wherein the second joint further includes a second body and a second pipe member installed at the rear end of the second body, and the pipe connecting portion is extended from the front end of the second body.

8. The gripper type dual stop-reversal quick-release connector according to claim 7, wherein the second stop-reversal member includes a hollow second pipe, and a second elastic member for pushing the second pipe towards the pipe connecting portion, and the rear end of the second pipe is passed through the second containing chamber and interconnected to the rear end of the second pipe member, and the second pipe has a second broken hole formed at a position proximate to the front end of the second pipe and interconnected to the interior of the second pipe, and the second pipe has a second pushing portion disposed at the front end of the second pipe and corresponsive to the first pushing portion.

9. The gripper type dual stop-reversal quick-release connector according to claim 8, wherein the second elastic member is installed between the second pipe and the second pipe member.

10. The gripper type dual stop-reversal quick-release connector according to claim 8, wherein the second pushing portion is in a concave conical shape.

11. A water supply device with a gripper type dual stop-reversal quick-release connector, comprising:
a pump;
a water tank; and
at least one first joint and at least one second joint, connected between the pump and the water tank;
wherein, the first joint has a first containing chamber interconnected to the front and rear ends of the first joint, and the first containing chamber includes a first stop-reversal member installed therein;
the second joint has a second containing chamber interconnected to the front and rear ends of the second joint, and the second containing chamber includes a second stop-reversal member installed therein, and the second joint is engaged with the first joint, such that the first and second stop-reversal members abut each other, and the first and second containing chambers are interconnected to each other; and
the first joint has a plurality of grippers disposed around the external periphery of the front end of the first joint, and the second joint has a pipe connecting portion disposed at the front end of the second joint, and the grippers are sheathed on the pipe connecting portion, and the pipe connecting portion has a radial flange disposed at the external periphery of the pipe connecting portion and corresponsive to the grippers, and each gripper is latched to the radial flange for fixation.

12. A water-cooling system with a gripper type dual stop-reversal quick-release connector, comprising:
a pump;
a water tank;
a water block;
a water-cooled exhaust; and
a circulation pipeline, serially coupled to the pump, the water tank, the water block and the water-cooled exhaust, and having at least one first joint and at least one second joint formed thereon;
wherein, the first joint has a first containing chamber interconnected to the front and rear ends of the first joint, and the first containing chamber includes a first stop-reversal member installed therein;
the second joint has a second containing chamber interconnected to the front and rear ends of the second joint, and the second containing chamber includes a second stop-reversal member installed therein, and the second joint is engaged with the first joint, such that the first and second stop-reversal members abut each other, and the first and second containing chambers are interconnected to each other; and
the first joint has a plurality of grippers disposed around the external periphery of the front end of the first joint, and the second joint has a pipe connecting portion disposed at the front end of the second joint, and the grippers are sheathed on the pipe connecting portion, and the pipe connecting portion has a radial flange disposed at the external periphery of the pipe connecting portion and corresponsive to the grippers, and each gripper is latched to the radial flange for fixation.
